(19) United States
(12) Patent Application Publication
(10) Pub. No.: US 2025/0235967 A1
(43) Pub. Date: Jul. 24, 2025

(54) APPARATUS FOR FORMING, SHAPING, AND PLANISHING A WORKPIECE

(71) Applicant: GM Global Technology Operations LLC, Detroit, MI (US)

(72) Inventors: Joshua Lee Solomon, Berkley, MI (US); Joel S. Hooton, Chesterfield, MI (US); Hui-ping Wang, Troy, MI (US); Lu Huang, Troy, MI (US); Dohyun Leem, Birmingham, MI (US)

(73) Assignee: GM Global Technology Operations LLC, Detroit, MI (US)

(21) Appl. No.: 18/419,783

(22) Filed: Jan. 23, 2024

(51) Int. Cl. B23Q 5/10; B21B 1/22; B23Q 1/01

(52) U.S. Cl. CPC B23Q 5/10; B21B 1/227; B23Q 1/015

(57) ABSTRACT

An apparatus including a frame comprising a first portion and a second portion spaced axially from the first portion along a longitudinal axis. The apparatus further including a first tool coupled to the first portion and configured to rotate about and translate along the longitudinal axis and a second tool coupled to the second portion and configured to rotate about the longitudinal axis.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a system for modifying sheet metal and, more particularly, to a system for rotating and translating tools which modify sheet metal.

Adding features to a sheet metal workpiece through incremental forming, shaping, and planishing via one or more tools may require rotating the workpiece or the tools to achieve a target geometry. Typically, this may be accomplished through complex articulation of the workpiece. However, constraints that result from reach, collision with equipment, and tool geometry have resulted in expensive and time-consuming techniques that negatively impact quality, fidelity, and feasibility of resulting features. Shortcomings of existing systems will be addressed by one or more aspects of the present disclosure.

### SUMMARY

In one configuration, an apparatus is provided and includes a frame including a first portion and a second portion spaced axially from the first portion along a longitudinal axis. The apparatus may further include a first unit coupled to the first portion, including a first tool coupled to the first portion and arranged along the longitudinal axis and a first motor coupled to the first portion for actuating the first tool about the longitudinal axis and with respect to the first portion. The apparatus may further include a second unit coupled to the second portion, including a second tool coupled to the second portion and arranged along the longitudinal axis and a second motor coupled to the second portion for actuating the second tool about the longitudinal axis and with respect to the second portion. The apparatus may further include a common interface for modifying a workpiece arranged axially between the first tool and the second tool.

The apparatus may include one or more of the following optional features. For example, the first unit may further include a first shaft coupled to the first portion of the frame at a first end and to the first tool at a second end, the first shaft may be configured to translate along and rotate about the longitudinal axis with respect to the frame. The first shaft may be configured to be externally actuated via a drive mechanism coupled to the first motor. The first shaft may be configured to translate along and rotate about the longitudinal axis at the same time. The first shaft may include an internal shaft and an external shaft, the internal shaft may be configured to translate along and rotate about the longitudinal axis with respect to the external shaft. The internal shaft may be configured to be internally actuated via a drive mechanism coupled to the first motor. The second unit may further include a tool platform coupled to second portion of the frame, the tool platform is configured to rotate about the longitudinal axis with respect to the frame. A position of the first tool and a position of the second tool may be continuously and simultaneously maintained by the first and second motors so that the first tool and the second tool remain tangent to a path of the workpiece within the common interface. The first unit and the second unit may be configured to receive identical electrical inputs to maintain consistent motion of the first and second units. The first tool and the second tool may be asymmetric. The first tool and the second tool may be symmetric. The first tool may be arranged along a first plane and the second tool may be arranged along a second plane.

In one configuration, an apparatus is provided and includes a frame including a first portion and a second portion spaced axially from the first portion along a longitudinal axis. The apparatus further including a first tool coupled to the first portion and configured to rotate about and translate along the longitudinal axis and a second tool coupled to the second portion and configured to rotate about the longitudinal axis.

The apparatus may include one or more of the following optional features. The second tool may be further configured to translate along the longitudinal axis via an actuator. The first tool and the second tool may be configured to rotate about and translate along the longitudinal axis continuously and simultaneously. A common interface may be arranged axially between the first tool and the second tool. A workpiece may be guided along a path within the common interface and contacted by the first tool and the second tool. A portion of the first tool and the second tool may contact the workpiece and remain tangent to the path within the common interface. The first tool and the second tool may be controlled by a computer. The first tool and the second tool may be controlled by a manual analogue input.

### BRIEF DESCRIPTION OF THE DRAWINGS

The drawings described herein are for illustrative purposes only of selected configurations and are not intended to limit the scope of the present disclosure.

FIG. 1 is a perspective view of an apparatus for modifying a workpiece according to the principles of the present disclosure;

FIG. 2 is a perspective view of the apparatus of FIG. 1:

FIG. 3 is a close-up perspective view of a drivetrain of the apparatus of FIG. 1:

FIG. 4 is a side view of the apparatus of FIG. 1;

FIG. 5 is a top view of a workpiece showing one or more positions of a first tool of the apparatus of FIG. 1; and

FIG. 6 is a perspective view of an apparatus for modifying a workpiece according to the principles of the present disclosure.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising.” “including.” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on.” “directly engaged to.” “directly connected to.” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second.” “third.” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second.” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below; the term “module” may be replaced with the term “circuit.” The term “module” may refer to, be part of, or include an Application Specific Integrated Circuit (ASIC): a digital, analog, or mixed analog/digital discrete circuit: a digital, analog, or mixed analog/digital integrated circuit: a combinational logic circuit: a field programmable gate array (FPGA): a processor (shared, dedicated, or group) that executes code: memory (shared, dedicated, or group) that stores code executed by a processor: other suitable hardware components that provide the described functionality: or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app.” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data. e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices: magnetic disks, e.g., internal hard disks or removable disks: magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube). LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well: for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user: for example, by sending web pages to a web browser on a user's client device in response to requests received from the web browser.

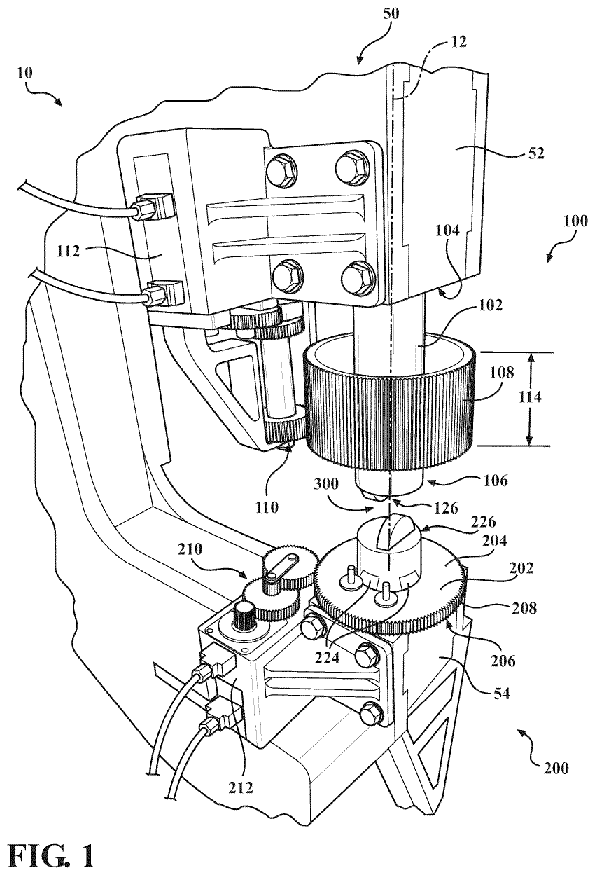

With specific reference to FIG. 1, an apparatus for modifying a workpiece (i.e., an apparatus) 10 is shown comprising a frame 50, a first or upper unit 100, and a second or lower unit 200. For the purposes of this disclosure, the term “modifying” may be used interchangeably with terms associated with machining a workpiece such as forming, shaping, and/or planishing.

With reference to FIG. 1, the frame 50 can include a first or upper portion 52 and a second or lower portion 54 spaced axially from the upper portion 52 along a first or longitudinal axis 12. The frame 50 may be stationary (e.g., coupled to the ground) or may be coupled to a robot, gantry device, or another device that can move the frame 50 along an additional axis so as to add an additional degree of freedom to the system 10.

The first or upper unit 100 may be coupled to the upper portion 52 of the frame 50. According to one aspect of the present disclosure, the upper unit 100 can include a first shaft 102 (e.g., a tool shaft) coupled to the upper portion 52 of the frame 50. More specifically, the first shaft 102 can have a first or proximal end 104 coupled to the upper portion 52 and an opposite second or distal end 106 spaced axially from the proximal end 104 along the longitudinal axis 12. The first shaft 102 may be movable with respect to the frame 50. In other words, the first shaft 102 may be configured so that it can rotate (e.g., via a gear set, pulleys, chain, belt, etc.) about the longitudinal axis 12 and/or translate (e.g., via an actuator with mechanical linkages, pneumatics, or hydraulics) along the longitudinal axis 12.

As shown in FIG. 1, a gear 108 may be arranged axially along an external portion of the first shaft 102 so that the first shaft 102 may be externally driven by one or more drive mechanisms 110 coupled to the upper portion 52 of the frame 50. The gear 108 may include a height 114 such that the gear 108 can maintain contact with at least one of the one or more drive mechanisms 110. Maintaining contact between the gear 108 and the one or more drive mechanisms 110 can provide control over a rotational position of the first shaft 102 before, during, and/or after translation of the first shaft 102, for example. The drive mechanisms 110 may be actuated by a first motor 112 which may also be coupled to the upper portion 52 of the frame 50. The first motor 112 may be coupled to and in communication with an industrial computer (e.g., a programmable logic controller, etc.) or a manual analogue input (e.g., a foot pedal) so that rotational speed and angle of the first motor 112 may be controlled.

According to another aspect of the present disclosure, an alternative to the first shaft 102 may be provided and include a first shaft 102′ that is coupled to the upper portion 52 of the frame 50. The first shaft 102′ may be one of a drill press, for example, that usually rotates and/or translates along the longitudinal axis 12. With reference to FIG. 6, the first shaft 102″ may include an internal shaft 116 arranged axially within an external shaft 118 along the longitudinal axis 12. The internal shaft 116 may be arranged within the external shaft 118 such that the internal shaft 116 can rotate (e.g., via a gear set, pulleys, chain, belt, etc.) about the longitudinal axis 12 and/or translate (e.g., via an actuator with mechanical linkages, pneumatics, or hydraulics) along the longitudinal axis 12. Additionally, the internal shaft 116 may rotate about and/or translate along the longitudinal axis 12 with respect to the external shaft 118. At a proximal end 104′, the internal shaft 116 may be configured to be internally actuated via the drive mechanism 110 and the first motor 112 described above. In other words, the internal shaft 116 may include a spline 120 which can be coupled with an internal spline 122 of the gear 108′. The gear 108′ can have a height 114′ which may be selected so that the spline 120 can remain in contact with the internal spline 122 of gear 108′ during translation of the internal shaft 116 along the longitudinal axis 12. Maintaining contact between the spline 120 and internal spline 122 can allow the internal shaft 116 to be internally driven before, during, and/or after translation along the longitudinal axis 12.

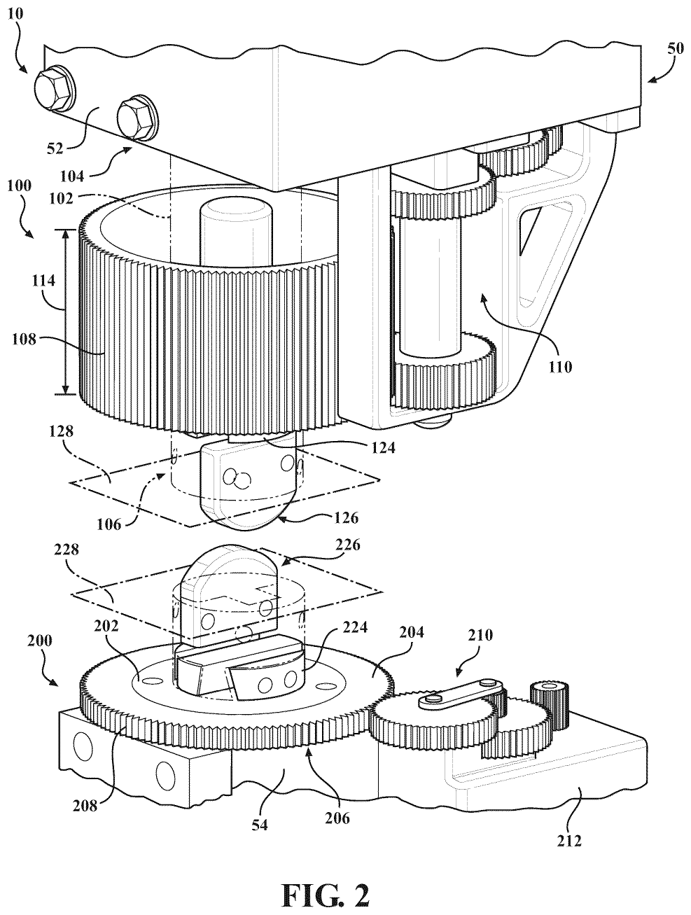

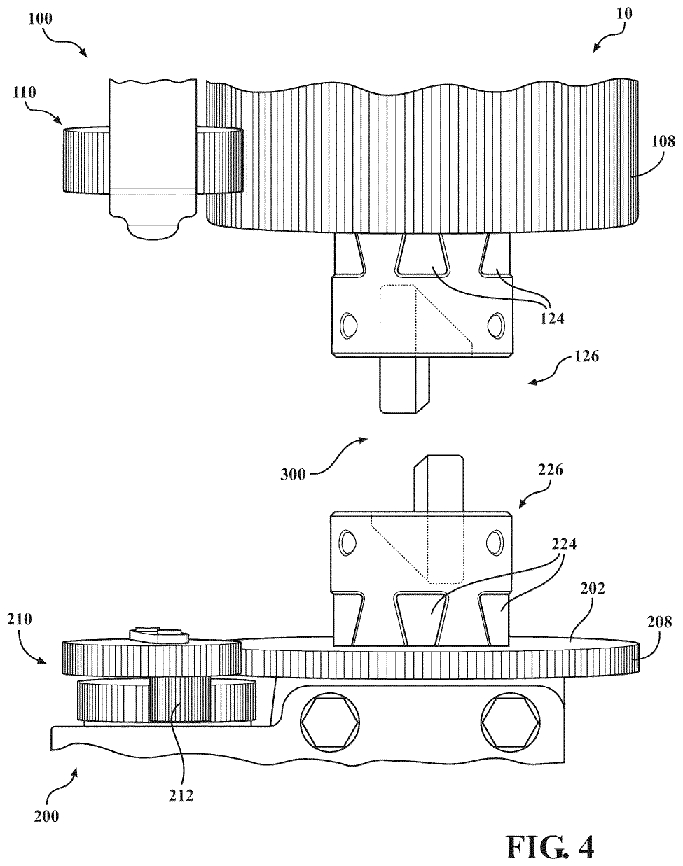

With reference to FIGS. 2 and 4, the first tool 126 can be coupled to the upper portion 52 and arranged along the longitudinal axis 12. The first shaft 102 may include a tool chuck 124 coupled to the distal end 106 of the first shaft 102 so that a first tool 126 may be removably coupled to the first shaft 102 at the distal end 106. The tool chuck 124 may be configured so that the first tool 126 may be easily interchanged with a variety of tools. For instance, the tool chuck 124 can include movable jaws or clamps that may easily engage and disengage with the first tool 126 to secure the first tool 126 to the first shaft 102. In general, the first tool 126 may include forming, shaping, and/or planishing tools that are configured to be interchangeable tools. The first tool 126 may include tools such as rollers, steppers, chisels, or other tools that can be used for forming, shaping, and/or planishing operations. The first tool 126 may also include incremental (e.g., hammering) or continuous (e.g., English wheel) forming, shaping, and/or planishing tools. Additionally or alternatively, the first tool 126 may be a tool that is configured to be rotated about the longitudinal axis 12. Also, the first tool 126 may be configured such that a position of a portion of the first tool 126 may be adjusted about a first plane 128. The first plane 128 may be an XY plane which extends through and is perpendicular to the longitudinal axis 12. Such adjustments of the first tool 126 about the first plane 128 may allow for further versatility of modifying a workpiece during operation, for example.

The upper unit 100 may duplicated and coupled to the lower portion 54 of the frame 50. Thus, the upper portion 52 and the lower portion 54 of the frame 50 may both have upper units 100 that are configured to rotate and translate with respect to the longitudinal axis 12.

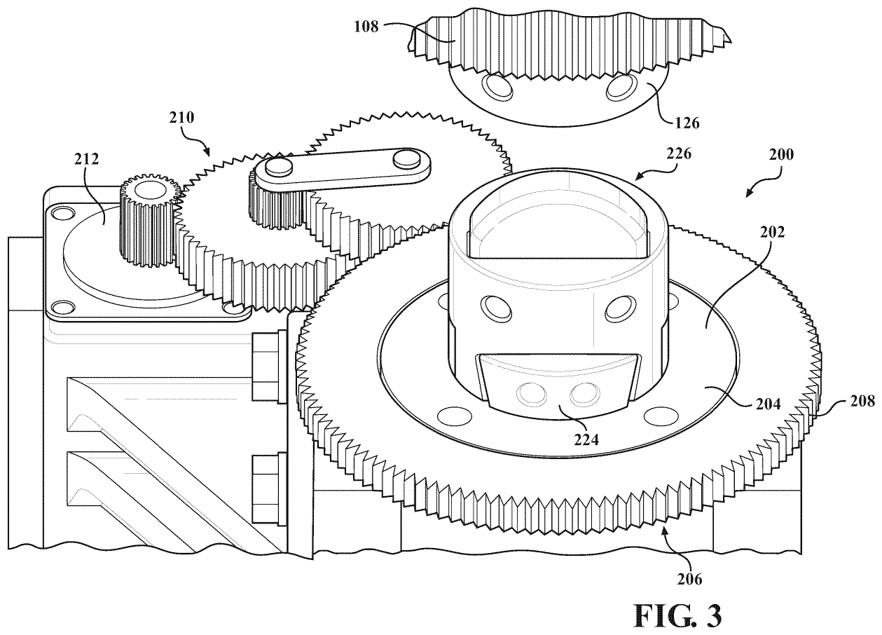

With reference again to FIG. 1, the second or lower unit 200 may be coupled to the lower portion 54 of the frame 50. Similar to the upper unit 100, the lower unit 200 may also include a shaft that is movable along the longitudinal axis 12 and with respect to the frame 50. Here, however, the lower unit 100 comprises a tool platform 202 coupled to the lower portion 54 of the frame 50. The tool platform 202 may include a first or upper surface 204 and an opposite second or lower surface 206. As best shown in FIG. 3, the upper surface 204 may face the first unit 100. The tool platform 202 can be configured so that the tool platform 202 can rotate about the longitudinal axis 12 and with respect to the frame 50. In other words, gear teeth 208 may be arranged radially around the tool platform 202 which can be actuated (e.g., via a gear set, pulleys, chain, belt, etc.), for example.

As shown in FIG. 1, the tool platform 202 may be coupled to and actuated by one or more drive mechanisms 210 coupled to the lower portion 54 of the frame 50. The drive mechanisms 210 may be identical to the drive mechanisms 110 coupled to the upper portion of the frame 52. The drive mechanisms 210 may be actuated through a second motor 212 that can be coupled to the lower portion 54 of the frame 50. The second motor 212 may be identical to the first motor 112 of the first or upper unit 100. The second motor 212 may be coupled to and in communication with an industrial computer (e.g., a programmable logic controller, etc.) or a manual analogue input (e.g., a foot pedal) so that rotational speed and angle of the second motor 212 may be controlled.

With reference to FIGS. 2 and 4, the second tool 226 can be coupled to the lower portion 54 and arranged along the longitudinal axis 12. The tool platform 202 may include a tool chuck 224 coupled to the upper surface 204 of the tool platform 202. The tool chuck 224 may be configured so that a second tool 226 may be easily interchanged with a variety of tools. The tool chuck 224 can include movable jaws or clamps that may easily engage and disengage with the second tool 226 to secure the second tool 226 to the tool platform 202. In general, the second tool 226 may include forming, shaping, and/or planishing tools that are configured to be interchangeable tools. The second tool 226 may include tools such as rollers, steppers, chisels, or other tools that can be used for forming, shaping, and/or planishing operations. The second tool 226 may also include incremental (e.g., hammering) or continuous (e.g., English wheel) forming, shaping, and/or planishing tools. Additionally or alternatively, the second tool 226 may be a tool that is configured to be rotated about the longitudinal axis 12. Also, the second tool 226 may be configured such that a position of a portion of the first tool 226 may be adjusted about a second plane 228. The second plane 228 may be an XY plane which extends through and is perpendicular to the longitudinal axis 12. Such adjustments of the second tool 226 about the second plane 228 may allow for further versatility of modifying a workpiece during operation, for example.

In operation, the first motor 112 can be coupled to the upper portion 52 for actuating the first tool 126 about the longitudinal axis 12 and with respect to the upper portion 52. Likewise, the second motor 212 can be coupled to the lower portion 54 for actuating the second tool 226 about the longitudinal axis 12 and with respect to the lower portion 54. Movement of the first unit 100 and the second unit 200 can be maintained through receipt of identical electrical inputs (e.g., linear or rotary encoders) and can be controlled independently of one another. Thus, a position of the first tool 126 and a position of the second tool 226 may be continuously and simultaneously maintained by the first and second motors 112, 212 which can provide parallel features on a workpiece 20. Additionally or alternatively, the position of the first tool 126 and the position of the second tool 226 can be independently maintained by the first and second motors 112, 212 which can provide tapered features on the workpiece 20. The position of the first tool 126 and the second tool 226 can be maintained so that the first tool 126 and the second tool 226 remain tangent to a path 22 of the workpiece 20 within a common interface 300. The common interface 300 for modifying the workpiece 20 can be arranged axially between the first tool 126 or upper unit 100 and the second tool 226 or lower unit 200, as shown in FIG. 1. The common interface 300 may be defined as a region between the first plane 128 and the second plane 228 or by a region axially between the first tool 126 and the second tool 226, for example. The first tool 126 and the second tool 226 may contact the workpiece 20 within the common interface 300 and modify the workpiece 20. In other words, the first tool 126 may contact an upper surface of the workpiece 20 and the second tool 226 can contact a lower surface of the workpiece 20. Note, the first tool 126 and second tool 226 may be asymmetric (e.g., the first tool 126 is a punch and the second tool 226 is a die) or symmetric (i.e., the first and second tools 126, 226 are the same tool). The workpiece 20 may be guided by an operator or a machine (e.g., a robot) along a predefined path and contacted by the first tool and the second tool 126, 226 within the common interface 300.

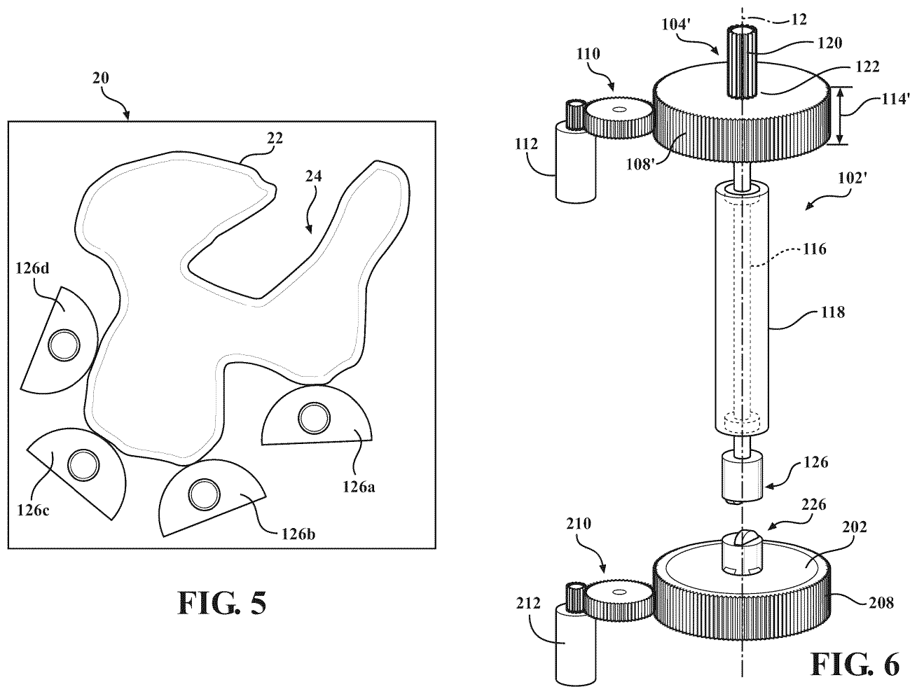

With reference to FIG. 5, a portion of the first tool 126 is shown at several different positions along the path 22 of a workpiece 20. As shown, at a first position 126a, a second position 126b, a third position 126c, and a fourth position 126d, the first tool 126 remains tangent to the path 22 of the workpiece 20. Note, while the second tool 226 is not shown in FIG. 5, the second tool 226 may also be controlled so that a portion of the second tool 226 also remains tangent to the path 22 of the workpiece 20. The first and second motors 112, 212 coupled to the drive mechanisms 110, 210 may be actuated to align the first and second tools 126, 226 to a desired location and direction. Manipulating the orientation of the first and second tools 126, 226 in this manner relative to the path 22 allows the first and second tools 126, 226 to form, modify, and/or displace custom geometric features 24 in the workpiece 20, for example.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. An apparatus, comprising:
a frame comprising a first portion and a second portion spaced axially from the first portion along a longitudinal axis:
a first unit coupled to the first portion, comprising:
a first tool coupled to the first portion and arranged along the longitudinal axis:
a first motor coupled to the first portion for actuating the first tool about the longitudinal axis and with respect to the first portion:
a second unit coupled to the second portion, comprising:
a second tool coupled to the second portion and arranged along the longitudinal axis,
a second motor coupled to the second portion for actuating the second tool about the longitudinal axis and with respect to the second portion; and
a common interface for modifying a workpiece arranged axially between the first tool and the second tool.

2. The apparatus of claim 1, wherein the first unit further comprises a first shaft coupled to the first portion of the frame at a first end and to the first tool at a second end, the first shaft is configured to translate along and rotate about the longitudinal axis with respect to the frame.

3. The apparatus of claim 2, wherein the first shaft is configured to be externally actuated via a drive mechanism coupled to the first motor.

4. The apparatus of claim 3, wherein the first shaft is configured to translate along and rotate about the longitudinal axis at the same time.

5. The apparatus of claim 2, wherein the first shaft comprises an internal shaft and an external shaft, the internal shaft is configured to translate along and rotate about the longitudinal axis with respect to the external shaft.

6. The apparatus of claim 5, wherein the internal shaft is configured to be internally actuated via a drive mechanism coupled to the first motor.

7. The apparatus of claim 1, wherein the second unit further comprises a tool platform coupled to second portion of the frame, the tool platform is configured to rotate about the longitudinal axis with respect to the frame.

8. The apparatus of claim 1, wherein a position of the first tool and a position of the second tool are continuously and simultaneously maintained by the first and second motors so that the first tool and the second tool remain tangent to a path of the workpiece within the common interface.

9. The apparatus of claim 1, wherein the first unit and the second unit are configured to receive identical electrical inputs to maintain consistent motion of the first and second units.

10. The apparatus of claim 1, wherein the first tool and the second tool are asymmetric.

11. The apparatus of claim 1, wherein the first tool and the second tool are symmetric.

12. The apparatus of claim 1, wherein the first tool is arranged along a first plane and the second tool is arranged along a second plane.

13. An apparatus, comprising:
a frame comprising a first portion and a second portion spaced axially from the first portion along a longitudinal axis:
a first tool coupled to the first portion and configured to rotate about and translate along the longitudinal axis; and
a second tool coupled to the second portion and configured to rotate about the longitudinal axis.

14. The apparatus of claim 13, wherein the second tool is configured to translate along the longitudinal axis via an actuator.

15. The apparatus of claim 14, wherein the first tool and the second tool are configured to rotate about and translate along the longitudinal axis continuously and simultaneously.

16. The apparatus of claim 13, wherein a common interface is arranged axially between the first tool and the second tool.

17. The apparatus of claim 16, wherein a workpiece is guided along a path within the common interface and contacted by the first tool and the second tool.

18. The apparatus of claim 17, wherein a portion of the first tool and the second tool contact the workpiece and remain tangent to the path within the common interface.

19. The apparatus of claim 18, wherein the first tool and the second tool are controlled with a computer.

20. The apparatus of claim 18, wherein the first tool and the second tool are controlled with a manual analogue input.
